(19) United States
(12) Patent Application Publication
(10) Pub. No.: US 2024/0427743 A1
(43) Pub. Date: Dec. 26, 2024

(54) CLOUD DATA PIPELINE ORCHESTRATOR

(71) Applicant: Wells Fargo Bank, N.A., San Francisco, CA (US)

(72) Inventors: Vijay Anusuri, Charlotte, NC (US); MaiLin Jan, Glen Cove, NY (US); Ramesh H. Joshi, Charlotte, NC (US); Sameer M. Joshi, Charlotte, NC (US); Suresh Kumar, Charlotte, NC (US); Ashish Lahoti, Round Rock, TX (US); Cedric Lamielle, Scottsdale, AZ (US); Hargurjit S. Malhi, Cave Creek, AZ (US); Lakshmikanth Nagapudi, Waxhaw, NC (US)

(21) Appl. No.: 18/339,566

(22) Filed: Jun. 22, 2023

(51) Int. Cl. G06F 16/21; G06F 16/215; G06F 16/23; G06F 16/25

(52) U.S. Cl. CPC G06F 16/214; G06F 16/215; G06F 16/2365; G06F 16/258

(57) ABSTRACT

An example computer system for data pipeline orchestration configured to manage and coordinate the end-to-end process involved in moving and transforming data from various sources to designated target repositories can include one or more processors; and non-transitory computer-readable storage media encoding instructions which, when executed by the one or more processors, causes the computer system to create: a user interface configured to receive metadata configuration requirements; a parsing module programmed to parse the metadata configuration requirements into one or more constituent components; and a template selection module programmed identify and select appropriate templates from a template repository used to fulfill the one or more constituent components.

### BACKGROUND

Data movement and migration between different data repositories, such as on-premises and cloud-based systems, can be a complex and time-consuming task for organizations. It often requires significant manual effort and expertise to ensure the smooth and efficient transfer of data while adhering to various data governance requirements and standards. Furthermore, the process of defining and implementing the necessary transformations and controls for data migration can be error-prone and challenging to manage.

### SUMMARY

A template-driven data pipeline orchestration system, product or method can be used to manage the movement of data from a source data repository (e.g., an on-premises server or a cloud storage) to a target data repository (e.g., another on-premises server or cloud storage). The system and method can leverage predefined templates that encapsulate complex business logic and incorporate enterprise data governance requirements, controls, and standards. The templates are used to define the necessary information for the data migration.

Examples provided herein are directed to a computer system for data pipeline orchestration. The system includes one or more processors and non-transitory computer-readable storage media containing instructions that enable the creation of components, including a user interface configured to receive metadata configuration requirements, a parsing module programmed to parse the metadata configuration requirements into one or more constituent components, and a template selection module programmed to identify and select appropriate templates from a template repository used to fulfill the one or more constituent components.

In some examples, the system includes an enterprise consideration module designed to incorporate data governance requirements into the data pipeline orchestration process, as an aid in ensuring that the resulting data pipelines adhere to enterprise-level data governance policies and standards. In some examples, the system features a directed acyclic graph (DAG) generator script creation module, configured to stitch together the selected templates along with the data governance requirements, resulting in the creation of a directed acyclic graph script. In some examples, the DAG script serves as a comprehensive blueprint for executing the data movement tasks, encompassing the necessary transformations, controls, and sequencing defined by the templates and governance requirements.

In one example, the metadata configuration requirements include at least one of a source data repository, a target data repository, or a transformation to be applied to data during a migration process. In one example, the metadata configuration requirements are in at least one of a JavaScript Object Notation (JSON), extensible Markup Language (XML) or Yet Another Markup Language (YAML) format.

In one example, the system further includes an enterprise consideration module program to incorporate data governance requirements. In one example, the template selection module leverages artificial intelligence to identify and select the appropriate template from the template repository. In one example, the templates encapsulate at least one of predefined logic, rules or configurations that address pipeline direct tasks or operations.

In one example, the system further includes a directed acyclic graph generator script creation module configured to stitch the selected templates together along with the data governance requirements to create a directed acyclic graph script. In one example, the user interface enables visualization of the directed acyclic graph script. In one example, the directed acyclic graph script enables parallel processing capabilities with portions of the script executed concurrently.

Examples provided herein are further directed to a computer program product residing on a computer-readable medium, containing a plurality of instructions that, when executed by a processor, enable the processor to perform operations for data pipeline orchestration. These operations include receiving metadata configuration requirements, parsing the metadata configuration requirements into one or more constituent components, and identifying and selecting appropriate templates from a template repository to fulfill the constituent components. In essence, the computer program product facilitates the execution of data pipeline orchestration by providing the necessary instructions to receive, parse, and select templates based on metadata requirements, ensuring the efficient and effective management of data pipelines.

Examples provided herein are further directed to a computer-implemented method executed on a computing device. The method comprises several steps for data pipeline orchestration, beginning with receiving metadata configuration requirements from one or more users, which serve as the input for the data movement process. The method includes parsing the metadata configuration requirements into their constituent components, which can involve breaking the metadata configuration requirements down into manageable units for further processing. The method encompasses the step of identifying and selecting suitable templates from a template repository that fulfill the requirements defined by the constituent components, to aid in ensuring that the generated data pipelines align with the specific needs and criteria specified by the metadata configuration requirements.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example data pipeline orchestration system for migrating data from a source data store to a target data store.

FIG. 2 shows an example data pipeline orchestration method to migrate and transform data from a source data storage repository to a target data storage repository.

FIG. 3 shows an example portion of a data pipeline orchestration system including a DAG generator script creation module.

FIG. 4 shows an example portion of a data pipeline orchestration system including a template repository and user interface configured to enable visualization of a DAG script.

FIG. 5 shows example physical components of the data pipeline device of the system of FIG. 1.

### DETAILED DESCRIPTION

This disclosure relates to the moving and transformation of data from various sources to one or more designated target repositories.

The concepts described herein provide a template-driven data pipeline orchestration system, product and method configured to move data from a source data repository (e.g., an on-premises server or a cloud storage) to a target data repository (e.g., another on-premises server or cloud storage). In some embodiments, the system, product and method operate by using templates that encapsulate complex business logic and incorporate enterprise data governance requirements, controls, and standards. These templates are used to define the necessary information for the data migration.

The template-driven data pipeline orchestration system, product and method offer several benefits. Firstly, examples provided herein streamline and automate the management of data pipelines, reducing the need for manual effort and potential errors. By utilizing a user interface and parsing module, the system, product and method simplify the process of defining metadata configuration requirements and breaking the configuration requirements down into manageable components. Additionally, the template selection module ensures the selection of appropriate templates from a repository, saving time and effort in creating data pipeline logic from scratch. Furthermore, examples provided herein promote consistency and adherence to enterprise data governance requirements. By incorporating an enterprise consideration module, the system, product and method aids in ensuring that the generated data pipelines align with data governance policies and standards, which helps organizations maintain data integrity, compliance, and security throughout the data movement process.

To initiate a migration, the user provides a set of requirements that outline specific details of the migration process. These requirements typically include information such as the source data repository (e.g., on-premises server or cloud storage), the target data repository (e.g., another on-premises server or a different cloud storage), and the platforms involved in the migration. Additionally, the user may specify any necessary transformations that need to be applied to the data during the migration process. These transformations can include data format conversions, data cleansing, aggregation, or any other operations required to ensure the compatibility and quality of the data in the target repository.

After receiving the migration requirements from the user, the data pipeline orchestration system, product, or method proceeds to parse these requirements into individual constituent components. The parsing process involves breaking down the requirements into granular action items or tasks to fulfill the data movement and transformation. In some examples, the parsed constituent components represent specific elements or steps within the data pipeline orchestration process. These components can include actions such as data extraction from the source repository, data transformation or manipulation, data validation, data loading into the target repository, or any other operations necessary to fulfill the migration requirements.

Following the parsing of the migration requirements into constituent components, the data pipeline orchestration system, product, or method proceeds to identify and select suitable templates from a template repository that can fulfill these components. In the context of data management, a “template” can refer to a predefined and reusable set of instructions, configurations, and logic that encapsulates a specific data movement or transformation process. In the examples provided herein, the templates encapsulate predefined logic, rules, and configurations that are designed to address common data pipeline tasks and operations.

The process of identifying and selecting templates involves matching the specific requirements of each constituent component with the corresponding templates available in the repository. The templates selected from the repository serve as building blocks or preconfigured modules that align with the requirements of the constituent components. The templates provide the ready-to-use logic and functionality needed to perform tasks such as data extraction, transformation, validation, and loading, while adhering to data governance requirements and standards.

Once the system, product, or method has identified and selected the appropriate templates for the constituent components, the system, product, or method proceeds to incorporate data governance requirements. These data governance requirements encompass not only the ones explicitly specified in the user-provided set of requirements but also any standing or previously established data governance requirements. Data governance requirements refer to the rules, policies, and standards that govern the management, usage, and protection of data within an organization. These requirements ensure data integrity, security, privacy, compliance, and quality throughout the data pipeline orchestration process. By incorporating data governance requirements, the system, product, or method ensures that the generated data pipelines adhere to the established governance framework, which may include implementing data access controls, encryption, data masking, anonymization, audit trails, or any other measures necessary to comply with regulations, industry standards, and internal policies.

After identifying and selecting the appropriate templates and incorporating the data governance requirements, the system, product, or method proceeds to stitch them together, forming a directed acyclic graph (DAG) script. A directed acyclic graph (DAG) is a computational graph that represents the flow and dependencies between various tasks or operations in a data pipeline. It consists of nodes, which represent individual tasks, and directed edges that indicate the dependencies between these tasks.

In the examples provided herein the DAG script defines the sequence of tasks to be executed, incorporating the logic, rules, and configurations specified by the templates, while also adhering to the data governance requirements. The DAG also ensures that tasks are executed in the correct order, considering their dependencies, to achieve the desired outcome. Accordingly, the DAG script serves as a blueprint or roadmap for executing the data pipeline, to guide the system, product, or method in performing the necessary operations, such as data extraction, transformation, validation, and loading, in a controlled and orchestrated manner. By representing the flow and dependencies between tasks, the DAG script ensures the efficient and accurate execution of the data pipeline, taking into account any required transformations, data governance rules, and compliance requirements.

The described system, product, and method can offer several advantages, particularly in improving computing and processing speed when moving and transforming data from diverse sources to designated target repositories. Other nonlimiting advantages of the data pipeline orchestration system, product and method can include:
Automated and Streamlined Process: The system, product, and method automate the data pipeline orchestration process, reducing the need for manual intervention and repetitive tasks, which accelerates the overall data movement and transformation process, improving computing speed and reducing processing time.
Template-Driven Approach: By utilizing templates, the system, product, and method provide preconfigured logic, rules, and configurations for common data pipeline tasks. Templates offer a standardized approach and eliminate the need for building data pipelines from scratch, resulting in faster development and reduced processing time.
Parallel Execution: The system, product, and method can leverage parallel processing capabilities. By breaking down the data pipeline into constituent components and tasks, these components can be executed concurrently, taking advantage of the available computing resources. Parallel execution significantly improves processing speed by distributing the workload across multiple processors or computing nodes.
Optimization and Efficiency: The system, product, and method incorporate best practices and optimization techniques into the data pipeline orchestration process, which ensures efficient data movement, intelligent scheduling of tasks, and optimized resource utilization. By minimizing redundant operations and optimizing the data flow, computing and processing speed are enhanced.
Scalability and Flexibility: The system, product, and method can scale to handle large volumes of data and diverse sources. They can adapt to changing requirements and accommodate additional data repositories or platforms. Scalability and flexibility contribute to improved computing speed and processing efficiency, allowing for seamless handling of data from various sources to designated target repositories.

Accordingly, the described system, product, and method optimize computing and processing speed through automation, template-driven approach, parallel execution, optimization techniques, and scalability. These advantages collectively contribute to faster data movement and transformation, enabling efficient processing of data from diverse sources to designated target repositories.

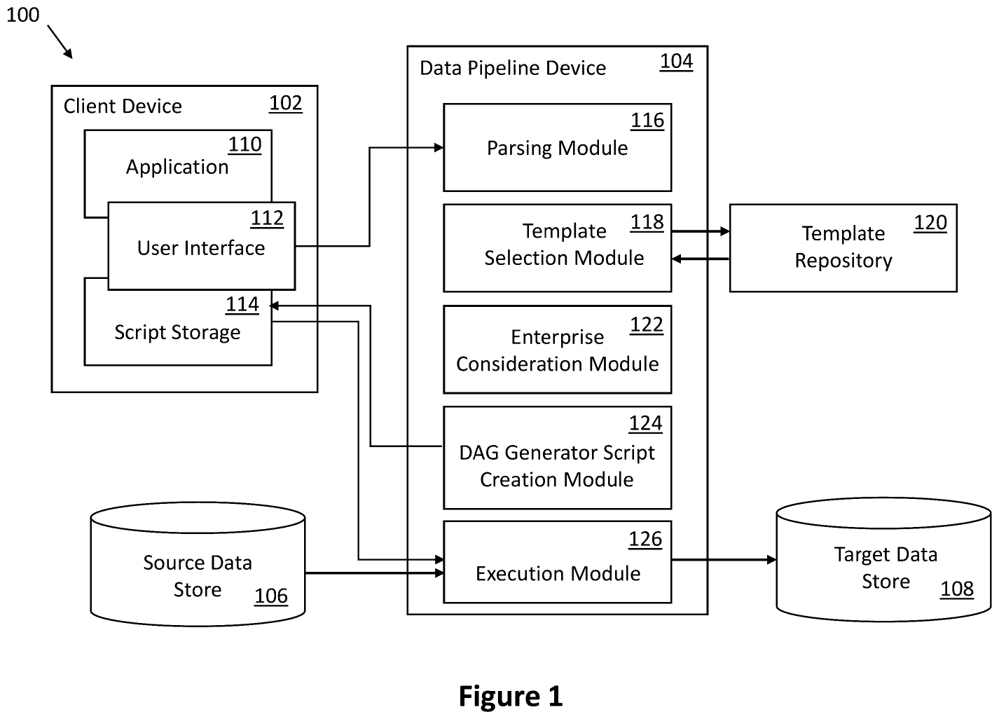

FIG. 1 schematically shows aspects of one example data pipeline orchestration system 100 programmed to migrate and transform data from a source data storage repository (e.g., an on-premises server, cloud storage, etc.) to a target data storage repository (e.g., a different on-premises server, cloud storage, etc.). The system 100 can be a computing environment that includes a plurality of client and server devices. As depicted, the system 100 includes client device 102, a data pipeline device 104, and data stores 106, 108. The client device 102, data pipeline device 104 and data stores 106, 108 can communicate through a network to accomplish the functionality described herein.

Each of the devices of the system 100 may be implemented as one or more computing devices with at least one processor and memory. Example computing devices include a mobile computer, a desktop computer, a server computer, or other computing device or devices such as a server farm or cloud computing used to generate or receive data. Although only a few devices are shown, the system 100 can accommodate hundreds or thousands of computing devices.

The example data stores 106, 108 are programmed to store information, such as customer information, transactional information (e.g., related to financial transactions), risk and compliance data, economic or market data, internal operations data, etc. As described further herein, the data store 106 functions as the source data store, and the data store 108 functions as the target data store.

The example architecture of the system 100 can be highly extensible to support different data stores. In some examples, the data stores supported include Oracle and MongoDB. However, the system 100 can be extended to support other types of data stores. Further, the system 100 can handle large volumes of data from the data stores 106, 108, which enables the system 100 to be scalable and address different technology choices.

The system 100, as described herein, is designed to efficiently manage and coordinate the entire process of copying data from data store 106, performing data transformation, and transferring the transformed data to data store 108. In some instances, the associated orchestration method can be initiated by automatically generating a script based on user input requirements, along with predefined standing requirements such as governance controls, operational metadata, and testing/validation controls. Throughout the data transfer and transformation process, any modifications made to the data are carefully captured and tracked to ensure the integrity of the data stored in data stores 106 and 108 is maintained.

In the example depicted in FIG. 1, the client device 102 hosts an application 110 that interacts with data from the data store 106 through an Application Programming Interface (API) or other mechanism, enabling the execution of various enterprise-related functions. For instance, the system 100 can offer financial services, and the client device 102 can be programmed to access data from the data store 106 to facilitate these financial services.

As further depicted, the application 110 is equipped with a user interface 112 to facilitate user interaction. For example, the user interface 112 can be configured to enable users to input metadata configuration requirements, providing a convenient way to define the necessary specifications for the data pipeline orchestration process.

Metadata configuration requirements refer to the specific details and instructions that govern the behavior, transformations, and handling of data during the pipeline orchestration. These requirements may vary depending on the specific use case and objectives of the data pipeline. Nonlimiting examples of metadata configuration requirements include:
Source and Target Data Repositories: Users can specify the source data repository (e.g., on-premises server, cloud storage) and the target data repository (e.g., different cloud platform, database system) where the data needs to be transferred or transformed.
Data Extraction and Transformation Rules: Users can define rules and instructions for extracting and transforming the data. For example, they can specify filtering criteria, aggregation methods, data format conversions, or any other necessary transformations.
Data Governance and Compliance Requirements: Users can provide guidelines and requirements related to data governance, privacy, security, and compliance, which may include specifying access controls, encryption protocols, data anonymization techniques, or compliance with regulatory standards such as GDPR or HIPAA.
Error Handling and Exception Management: Users can define how the system should handle errors and exceptions encountered during the data pipeline process, which can involve specifying error logging, retry mechanisms, notification protocols, or alternative data processing paths.
Scheduling and Frequency: Users may define scheduling parameters such as the frequency of data transfers or pipeline execution, time zones, or specific time windows during which the data movement should occur.

In certain implementations, the configuration requirements are captured and represented as JavaScript Object Notation (JSON) events, thereby enabling the serialization and transmission of complex data structures, making it suitable for representing metadata configuration requirements in a structured and interoperable format, as well as enabling efficient communication between the client device 102 and the data pipeline device 104, facilitating the exchange of information related to the data pipeline orchestration process. Alternatively, the use of other formats, such as XML, YAML, or proprietary formats, may be utilized based on system requirements, compatibility, or specific implementation choices.

The configuration requirements received by the data pipeline device 104 are subjected to further processing facilitated by a parsing module 116. In some implementations, the parsing module 116 extracts the relevant information and divides it into constituent components, thereby enabling subsequent steps in the data pipeline orchestration process. For example, in some implementations, the parsing module 116 transforms received JSON data into a structured representation that allows for easy navigation and processing. Once the parsing is complete, the module identifies specific elements within the JSON structure that encompass the essential metadata configuration details, extracting and isolating them for further analysis. The parsing module 116 also conducts thorough validation and verification procedures to ensure the integrity and accuracy of the extracted data, scrutinizing its compliance with the expected JSON schema or predefined validation rules.

In certain implementations, the parsing module 116 can identify different components or attributes within the JSON structure, which correspond to distinct aspects of the data pipeline orchestration. These components can encompass elements like source and target data repositories, transformation rules, governance requirements, or scheduling parameters. By skillfully mapping the extracted data to appropriate data structures or objects within the data pipeline orchestration system, the parsing module 116 empowers subsequent modules or components to effortlessly access and effectively utilize the parsed configuration requirements. Furthermore, the parsing module 116 may include comprehensive error handling mechanisms to promptly address any potential issues or inconsistencies encountered during the processing of the JSON configuration requirements. In some implementations, the parsing module 116 can log errors, provide informative error messages, and can initiate exception handling routines as necessary to ensure a seamless orchestration process.

Once the configuration requirements have been parsed into constituent components, these components are passed on to the template selection module 118, which serves to identify and select suitable templates from a template repository 120 to fulfill the specific needs of each constituent component. Each of the templates stored in the template repository 120 relate to a preconfigured and reusable set of instructions, configurations, and logic that encapsulates a particular data movement or transformation process. In some implementations, these templates serve as standardized blueprints that capture best practices, business rules, and data governance requirements for specific tasks within the data pipeline.

The template selection module 118 employs a systematic approach to choose appropriate templates for each constituent component. In some implementations, the template selection module 118 analyzes the requirements of each component and matches them with the available templates in the template repository 120. The selection process considers factors such as the nature of the data transformation, data sources and targets involved, required governance controls, and compliance standards. The template selection module 118 then evaluates the compatibility and relevance of each template to the constituent component's specific requirements, and selects the templates that align most effectively with the defined needs, ensuring that the resulting data pipeline adheres to the desired functionality, governance, and quality standards.

In certain implementations, the template selection module 118 can leverage artificial intelligence or machine learning AIML to facilitate the template selection process. For example, the template selection module 118 can include one or more feedforward neural networks, convolutional neural networks (CNNs), or recurrent neural networks (RNNs), depending on the specific requirements and nature of the data.

For example, in one implementation, the template selection module 118 can be trained using a dataset that includes various metadata configuration requirements and their corresponding successful template selections. The dataset can be curated to provide a wide range of scenarios, templates, and their applicability to different constituent components. The neural network is trained on the prepared dataset, with the features of the constituent components as input and the corresponding successful template selections as the target output. The training process involves iteratively adjusting the network's parameters to minimize the error between predicted and actual template selections. Cross-validation techniques can be used to ensure the model's generalizability.

Once the neural network is trained, it can be utilized for template selection. For example, the parsed constituent components of the configuration requirements, along with any additional relevant information, can be transformed into numerical or categorical features configured to capture the characteristics and requirements of each constituent component. The numerical or categorical features can then be fed into the trained neural network, which can predict the most suitable templates based on the learned patterns and associations between the input features and successful template selections from the training data.

In one implementation, the parsing module 116 incorporates a natural language processor (NLP) that understands and interprets human language. The parsing module 116 can analyze the metadata configuration requirements provided in text format and extract key information using techniques like entity recognition, part-of-speech tagging, and syntactic parsing, which enables the parsing module 116 to understand the semantics and structure of the requirements.

In some implementations, the parsing module 116 identifies important aspects of the requirements such as source and target data repositories, transformation rules, governance requirements, or scheduling parameters, enabling the parsing module 116 to extract these requirements as structured data that can be used for further processing. The templates in the template repository 120 can be annotated with metadata that describe their functionalities, data formats, transformations, and associated governance controls. The metadata enables the template selection module 118 to align the requirements identified by the parsing module 116 with the appropriate templates stored in the template repository 120.

Leveraging the semantic understanding provided by the NLP techniques, the template selection module 118 matches the extracted requirements with the annotated metadata of the templates. The template selection module 118 assesses the semantic similarity and relevance between the requirements and the templates, considering factors like data flow, transformation logic, and governance requirements. The template selection module 118 can then rank and select the most suitable templates that align with the parsed requirements. The ranking can be based on similarity scores, relevance measures, or predefined criteria. The selected templates are then recommended for use in the data pipeline orchestration.

In some implementations, the NLP-powered modules can continuously learn from user feedback and adapt to new patterns and requirements, thereby enabling the modules (e.g., parsing module 116, template selection module 118, etc.) to refine their understanding of the requirements and enhance the accuracy and effectiveness of the template selection process over time, thereby enabling a more intuitive and user-friendly approach to template selection, as users can provide requirements in a more natural and expressive manner.

The enterprise consideration module 122 can serve to incorporate data governance requirements within the data pipeline orchestration process. Data governance involves defining and implementing policies, procedures, and controls to ensure the proper management, accessibility, integrity, and security of data throughout its lifecycle. The enterprise consideration module 122 takes into account various aspects of data governance, including compliance with industry standards, legal requirements, and internal policies set by the organization. Accordingly, by integrating the enterprise consideration module 122, the system 100 can enforce and adhere to data governance principles, guidelines, and regulations.

In some implementations, the enterprise consideration module 122 can aid in ensuring that the data pipeline orchestration process adheres to the defined governance policies and rules, by validating that the selected templates, transformations, and data movement actions align with the established governance standards. In some implementations, the enterprise consideration module incorporates mechanisms to enforce access control policies and security measures during data movement and transformation, to assist in ensuring that only authorized individuals or systems can access and manipulate the data, safeguarding sensitive or confidential information.

In some implementations, the enterprise consideration module 122 can incorporate checks and controls to maintain data quality and consistency throughout the data pipeline. For example, the enterprise consideration module 122 can be configured to perform data validation, cleansing, standardization, and other data quality measures to ensure accurate and reliable data within the pipeline. In some implementations, the enterprise consideration module facilitates auditing and compliance monitoring of the data pipeline activities, to enable the tracking and recording of data changes, transformations, and movements, ensuring transparency and accountability for regulatory purposes. In some implementations, the enterprise consideration module 122 governs the management of metadata, which can provide contextual information about the data as an aid in ensuring that the required metadata is captured, stored, and made available for future reference, data lineage, and data governance reporting.

The directed acyclic graph (DAG) generator script creation module 124 is programmed to organize the selected templates and incorporate the data governance requirements to create a directed acyclic graph script. The script represents the flow and dependencies of tasks within the data pipeline orchestration.

In some implementations, the DAG generator script creation module 124 takes the selected templates, which encapsulate the necessary logic and actions for each task, and aligns them according to the desired sequence and dependencies. The DAG generator script creation module 124 can consider factors such as data transformation requirements, source and target repositories, and any additional criteria specified by the templates. The DAG generator script creation module 124 can also incorporate the data governance requirements into the script. These requirements encompass various aspects, including compliance rules, security measures, data quality controls, and other governance considerations specified by the organization.

By combining the selected templates and data governance requirements, the DAG generator script creation module 124 forms a directed acyclic graph script. The script outlines the order and relationships between the tasks in the data pipeline, ensuring that the data flows from the source to the target while adhering to the specified governance requirements. The resulting script represents a blueprint for executing the data pipeline, providing clear instructions on how the tasks should be orchestrated and coordinated, while facilitating the efficient and controlled movement, transformation, and validation of data.

Once generated, the directed acyclic graph script can be communicated to the client device 102 for storage and further use. For example, in some implementations, the script can be stored in the script storage repository 114, where it serves as a reference for the execution and maintenance of the data pipeline.

After selecting the appropriate script from the script storage repository 114, the user can initiate the processing of the identified script using the execution module 126. Thereafter, the execution module 126 executes the instructions contained within the script, enabling the movement, duplication, and transformation of data from the source data store 106 to the target data store 108. The execution module 126 ensures that the data is processed accurately, efficiently, and securely throughout the execution of the script. The execution module 126 orchestrates the flow of data, coordinates the sequence of tasks, and may incorporate error handling mechanisms to handle any potential issues encountered during the execution process.

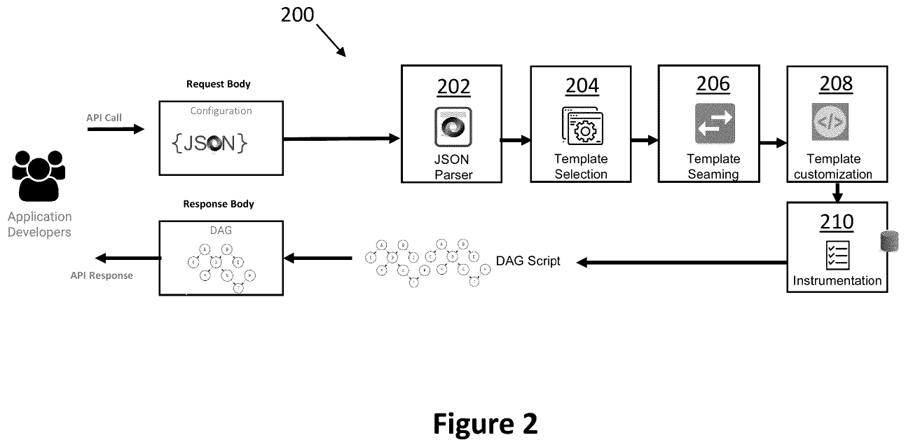

Referring now to FIG. 2 an example computer implemented method for data pipeline orchestration method 200 is shown. This example method 200 can be performed by the system 100 described above.

At operation 202, metadata configuration requirements are received, which provide details for the data pipeline orchestration process. One commonly used format for representing metadata configuration requirements is JSON (JavaScript Object Notation). In such a format, the metadata configuration requirements can be organized into key-value pairs, forming a hierarchical structure. Moreover, such a format can allow for easy representation of complex data structures, enabling the inclusion of different types of data, such as strings, numbers, arrays, and nested objects.

While JSON can be used, the use of other data formats for the metadata configuration requirements is also contemplated, which can include XML, YAML, or any other suitable data representation format based on the requirements of the system and the preferences of the users. In some embodiments, the metadata configuration requirements can be input by one or more users, such as application developers, through the user interface 112 of an Application Programming Interface (API), thereby enabling users to interact with the system and define the specific configuration parameters, rules, and preferences required for the data pipeline orchestration.

Further at operation 202, the metadata configuration requirements undergo parsing, where information from the metadata configuration requirements can be extracted and organized into one or more constituent components. The parsing techniques employed at operation 202 enable the identification of different components or attributes within the configuration requirement structure, each corresponding to distinct aspects of the data pipeline orchestration. These components represent elements of the data pipeline orchestration, such as the source and target data repositories, transformation rules, governance requirements, or scheduling parameters. By accurately mapping the extracted data to appropriate data structures or objects within the data pipeline, operation 202 facilitates seamless accessibility and effective utilization of the parsed configuration requirements and subsequent operations.

Furthermore, operation 202 can ensure robust error handling capabilities to swiftly address any potential issues or inconsistencies that may arise during the processing of the configuration requirements. For example, one or more errors can be logged at operation 202, to provide informative error messages, and in some cases initiate exception handling routines as necessary to maintain the smooth flow of the method 200.

At operation 204, one or more templates can be identified and selected to fulfill the one or more constituent components. In some examples, the templates are preconfigured and reusable sets of instructions, configurations, and logic that encapsulate specific data movement or transformation processes. In some examples, the templates can act as standardized blueprints that embody best practices, business rules, and data governance requirements for various tasks within the data pipeline. The templates provide a structured and efficient approach to executing common data operations while ensuring adherence to established standards.

Operation 204 can involve a systematic approach to choose the most suitable templates for each constituent component. For example, operation 204 can involve the analysis of the requirements of each component and matching of the requirements with the available templates (e.g., stored in a template repository). The selection process of operation 204 can consider various factors, including the nature of the data transformation, the involved data sources and targets, the required governance controls, and compliance standards. Furthermore, at operation 204 the compatibility and relevance of each template to the specific requirements of the constituent component can be evaluated. In particular, assessments can be made as to how well each template aligns with the defined needs, ensuring that the resulting data pipeline maintains the desired functionality, governance, and quality standards.

Further, at operation 204, data governance requirements within the data pipeline orchestration process can be incorporated. In certain implementations, it is validated at operation 204 that the selected templates, transformations, and data movement actions align with the established governance standards. Operation 204 can aid in ensuring adherence to defined governance policies and rules, guaranteeing that the data pipeline orchestration process operates within the prescribed boundaries.

In operation 206, the selected templates undergo a stitching process, resulting in the creation of a directed acyclic graph (DAG) script to organize the templates and incorporate the data governance requirements to establish a well-structured and efficient data pipeline orchestration. Using the selected templates as building blocks, a script creation module aligns the templates in a desired sequence and establishes the dependencies between tasks. This sequencing is based on factors such as data transformation requirements, source and target repositories, and any additional criteria specified within the templates. By carefully organizing the templates, at operation 206, the script can be created such that each task is executed in the appropriate order to maintain the integrity and flow of data within the pipeline.

The created directed acyclic graph script serves as a comprehensive blueprint for executing the data pipeline. The directed acyclic graph script provides clear instructions on how the tasks should be orchestrated and coordinated, ensuring that the data flows from the source to the target while adhering to the specified governance requirements. The script enables the efficient and controlled movement, transformation, and validation of data, facilitating the smooth execution of the data pipeline orchestration process.

At operation 208, the data pipeline orchestration system allows users the option to customize an existing template to cater to the specific requirements of a particular situation. This customization capability empowers users to adapt and tailor the templates according to their unique needs and circumstances. By customizing the template, users can optimize the data pipeline process to align precisely with their specific use case, industry standards, or organizational policies. The customization process may involve adjusting the template's configurations, parameters, or logic to suit the specific scenario. Users can modify the template's actions, dependencies, or sequence of tasks to accommodate the specific data sources, targets, or transformations involved. This customization enables users to fine-tune the data pipeline to meet their exact needs, ensuring optimal performance and outcomes.

At operation 210, the data pipeline orchestration system can capture metadata related to the data pipeline orchestration process and store the data in a dedicated database. In some examples, the metadata serves as a valuable record and reference for various aspects of the data pipeline. The captured metadata can include essential information about the executed data pipeline, such as the configuration settings, selected templates, data sources and targets, transformation rules, and any associated governance requirements. The metadata can provide a comprehensive snapshot of the entire data pipeline orchestration process, enabling traceability, auditability, and transparency.

Further, by storing the metadata in a database, the method 200 ensures the availability of historical information for future analysis, troubleshooting, and reporting purposes, while facilitating the understanding of past data pipeline executions, allowing users to assess performance, identify bottlenecks, and make informed decisions for optimization and improvement. The captured metadata also supports data lineage tracking, enabling users to trace the origin and transformation history of specific data elements within the pipeline. Furthermore, the captured metadata serves as a knowledge base, enabling users to leverage past experiences, successful configurations, and best practices for future data pipeline orchestration tasks.

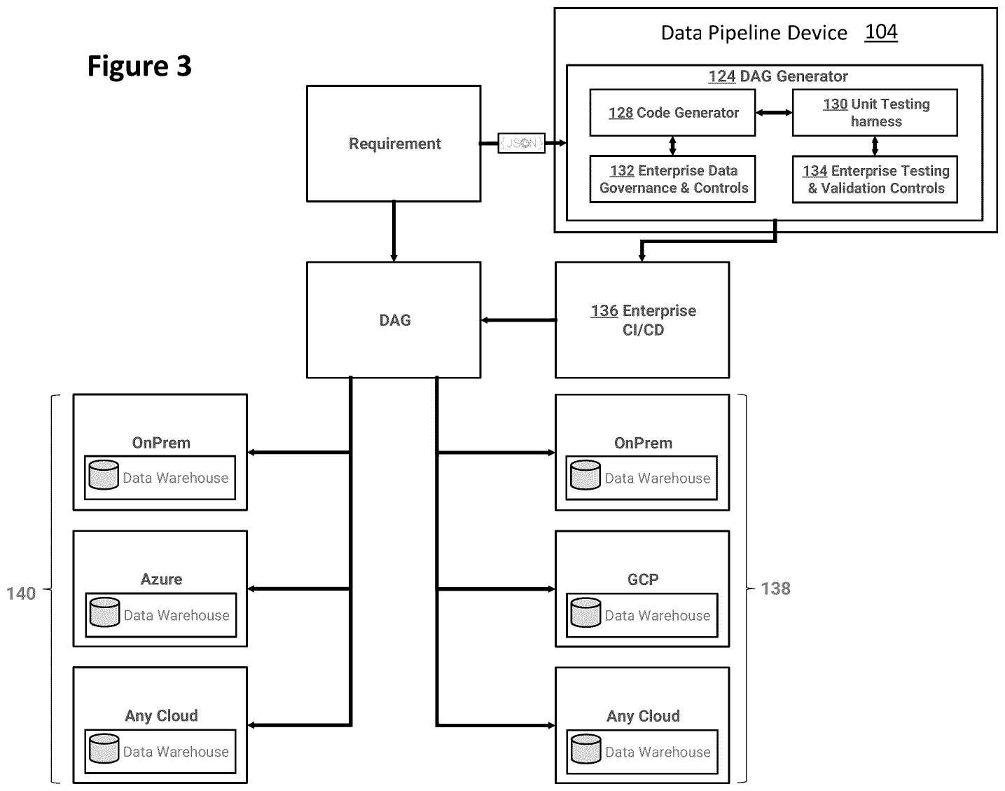

With additional reference to FIG. 3, in some embodiments, the DAG generator script creation module 124 can further be broken down into constituent components of a code generator module 128, a unit testing harness module 130, an enterprise data governance and control module 132, and an enterprise testing and validation control module 134.

The code generator module 128 translates the high-level instructions and logic encapsulated in the templates into executable code that implements the desired data movement, transformation, and governance actions. The code generator module 128 leverages the information provided by the template selection module 118, the parsed metadata configuration requirements, and the data governance considerations to produce code tailored to the specific data pipeline requirements. The code generator module 128 ensures accuracy, efficiency, and consistency in the generation of code by following predefined coding standards, best practices, and established patterns, and eliminates the need for manual coding and reduces the potential for human error, enhancing the reliability and repeatability of the data pipeline orchestration process.

The unit testing harness module 130 is responsible for creating a comprehensive suite of tests that evaluate the individual components, functionalities, and interactions within the data pipeline. The unit testing harness module 130 allows for the systematic and automated testing of the generated code, ensuring that each component performs as expected and meets the defined requirements. By employing various testing techniques and methodologies, such as unit testing, integration testing, and end-to-end testing, the unit testing harness module 130 verifies the correctness, performance, and robustness of the data pipeline. The unit testing harness module 130 identifies and helps rectify any potential issues, bugs, or inconsistencies in the code, ensuring that the data pipeline operates smoothly and reliably. The unit testing harness module 130 facilitates the detection of errors and anomalies early in the development cycle, enabling prompt remediation and reducing the risk of data integrity or system failures, and promotes a systematic approach to quality assurance, enabling the data pipeline orchestration system to meet or exceed the expected standards of reliability and functionality.

The enterprise data governance and control module 132 incorporates mechanisms to enforce data governance practices, control access privileges, and ensure compliance with regulatory requirements. The enterprise data governance and control module 132 facilitates the implementation of data governance controls, such as data classification, data privacy, data security, and data retention policies, throughout the data pipeline. By integrating the enterprise data governance and control module 132, organizations can maintain data integrity, confidentiality, and traceability. The module establishes mechanisms for auditing, monitoring, and logging data-related activities within the data pipeline, promoting transparency and accountability. Additionally, the enterprise data governance and control module 132 facilitates the management of metadata and data lineage as an aid in ensuring that metadata is captured, stored, and available for reference, enabling data lineage tracking, impact analysis, and governance reporting, which enhances the ability to track the origin, transformations, and usage of data within the data pipeline, supporting compliance, regulatory, and audit requirements. Furthermore, the enterprise data governance and control module 132 enables the integration of data governance policies and procedures into the data pipeline orchestration process. It ensures that data movement, transformation, and storage adhere to established governance guidelines, facilitating compliance with internal and external regulations.

The enterprise testing and validation controls module 134 encompasses a range of testing and validation mechanisms to verify the integrity, functionality, and performance of the data pipeline. The enterprise testing and validation controls module 134 enables comprehensive testing of the entire pipeline, including data movement, transformation processes, and governance controls. By employing techniques such as data validation, data quality checks, and reconciliation processes, the enterprise testing and validation controls module 134 validates the correctness and consistency of the data flowing through the pipeline, to ensure that the transformed data adheres to predefined rules, business logic, and quality standards. Furthermore, the enterprise testing and validation controls module 134 facilitates end-to-end testing to verify the overall functionality and effectiveness of the data pipeline orchestration process, and it performs validation checks on various aspects, including data completeness, accuracy, and compliance with regulatory requirements. The enterprise testing and validation controls module 134 contributes to maintaining data quality, identifying potential errors or discrepancies, and preventing data integrity issues, and supports organizations in meeting regulatory and compliance obligations by providing a robust mechanism for validating data accuracy, reliability, and consistency. Moreover, the enterprise testing and validation controls module 134 assists in the identification and resolution of issues through error detection, logging, and reporting, and enables organizations to monitor the performance of the data pipeline, track the success of data transformations, and identify areas for improvement.

The DAG generator script creation module 124 can leverage machine learning or artificial intelligence techniques to enhance the process of creating the DAG script. By utilizing these technologies, the module can analyze patterns, learn from historical data, and make intelligent decisions to generate an optimized and efficient DAG script.

One approach is to train machine learning models on a large dataset of historical data pipeline configurations and their corresponding DAG scripts. The models can learn the relationships between the configuration requirements, selected templates, and the resulting DAG scripts. Through this training process, the models can identify common patterns, dependencies, and optimizations that lead to effective data pipeline orchestration.

Once the models are trained, the DAG generator script creation module 124 can utilize the models to predict or generate the DAG script based on the given metadata configuration requirements. The module can input the configuration requirements into the trained models, which will use their learned knowledge to generate a script that aligns with best practices and optimizes the data pipeline orchestration process. Furthermore, the module can incorporate artificial intelligence techniques such as natural language processing (NLP) to interpret and understand the user's requirements expressed in natural language. NLP algorithms can parse and extract relevant information from the user's input, enabling the module to better comprehend the intent and context of the requirements. This understanding can guide the module in selecting appropriate templates and organizing the DAG script more effectively.

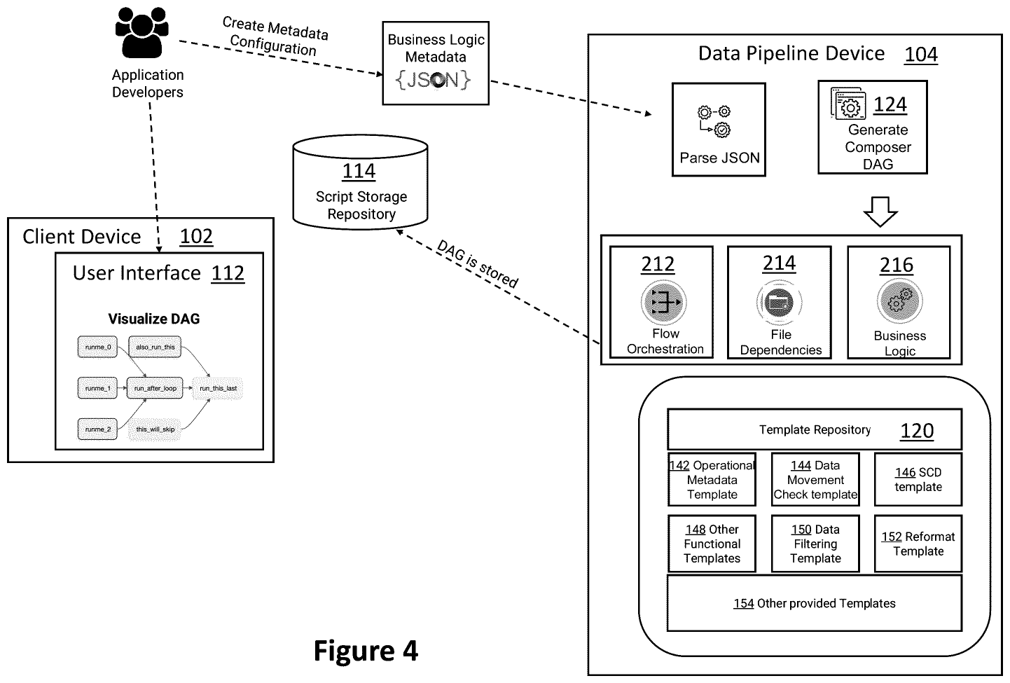

With additional reference to FIG. 4, in some embodiments, composition of the DAG script can involve a series of operations including flow orchestration 212, file dependency operations 214, and business logic operation 216. During flow orchestration 212 the application 110 analyzes the dependencies and relationships between different tasks within the DAG script. The application 110 determines the logical order in which these tasks should be executed to achieve the desired data movement and transformation, which includes considering any dependencies on previous tasks or specific conditions that need to be met before certain tasks can be initiated. In some implementations, flow orchestration 212 may involve defining parallelism, concurrency, or conditional branching within the DAG script, thereby enabling the system to optimize the execution of tasks, allowing for efficient utilization of resources and parallel processing when applicable, while ensuring that the data flows through the pipeline in a controlled and organized manner, preventing data bottlenecks or inconsistencies.

File dependency operations 214 can be employed in scenarios where the execution of certain tasks within the DAG script is dependent on the availability, completion, or specific conditions related to certain files or data sources, to ensure that the data pipeline proceeds in a controlled manner, considering the dependencies between different files or data sets. In some implementations, file dependency operations 214 may involve tasks such as checking the existence or completeness of required input files, monitoring for changes or updates in specific files, or coordinating the synchronization of data between different files or data sources. These operations ensure that the data pipeline proceeds smoothly and that each task has access to the necessary input files before execution.

The business logic operation 216 incorporates the organization's specific requirements, criteria, and decision-making processes to determine the most suitable templates for each component of the data pipeline. By leveraging the business logic, the system 100 can evaluate the compatibility, relevance, and applicability of the available templates in the template repository 120. The business logic operation 216 takes into account factors such as data transformation needs, source and target repositories, data governance requirements, and any additional criteria defined by the organization, and applies custom algorithms, rules, or scoring mechanisms to assess the templates' fitness for the specific data pipeline task at hand.

The template repository 120 can encompass a diverse range of templates, catering to various aspects of the data pipeline orchestration process. These templates serve as preconfigured and reusable sets of instructions, configurations, and logic that encapsulate specific tasks and requirements. Nonlimiting examples of the different types of templates that can be included in the template repository include:
Operational metadata templates 142: These templates capture and define the operational metadata requirements for the data pipeline, including information such as source and target data locations, data format specifications, data schema definitions, and data lineage tracking.
Data movement check templates 144: These templates provide instructions and logic to ensure the integrity and accuracy of data movement operations. They include checks and validations to verify that the data being transferred or copied between repositories is complete, consistent, and conforms to predefined rules or standards.
SCD (Slowly Changing Dimension) templates 146: These templates facilitate the handling of slowly changing dimension scenarios, where the attributes of certain data entities may change over time. SCD templates define the logic and procedures to manage the updates, inserts, or deletes of data to maintain accurate historical records.
Functional templates 148: These templates define specific functional operations or transformations that need to be applied to the data during the pipeline execution. They encompass tasks such as aggregations, calculations, filtering, enrichment, or data quality improvements.
Data filtering templates 150: These templates provide rules and criteria for filtering data based on specific conditions, allowing the selection or exclusion of data based on predetermined criteria. They enable the customization of the data pipeline to focus on specific subsets of data.
Reformatting templates 152: These templates define the procedures and instructions to reformat or transform data from one structure or format to another. They encompass tasks such as data type conversions, data mapping, data normalization, or data translation.
Other provided templates 154: This category includes additional templates that may be specific to the organization's needs or industry requirements. These templates can cover a wide range of tasks, such as data enrichment, data deduplication, data validation rules, data encryption, or data masking.

In the example shown in FIG. 3, the system 100 includes a continuous integration/continuous deployment (CI/CD) module 136. CI involves the regular integration of code changes and updates from multiple developers into a shared repository, ensuring frequent merging, testing, and validation to maintain codebase stability and quality. Within the DAG generator script creation module 124, CI involves seamlessly integrating template updates, metadata configuration changes, and code modifications into the data pipeline orchestration system, enabling continuous evolution and improvement to align with changing requirements and best practices.

Continuous Deployment focuses on automating the deployment and release of software updates, ensuring efficient and reliable delivery to the production environment. In the context of the DAG generator script creation module 124, CD entails automatically deploying the generated DAG scripts into the data pipeline environment. This enables the coordinated movement, transformation, and validation of data based on the predefined pipeline specifications. By leveraging CI/CD practices, the system streamlines development, testing, and deployment processes, promoting agility, early issue detection, and efficient delivery of updates.

Once the directed acyclic graph (DAG) script is generated, it can be stored within the system for future execution. For example, in some embodiments, the DAG script can be stored in a script storage repository 114 (as depicted in FIG. 4). The DAG script serves as a blueprint that outlines the sequence and dependencies of tasks involved in the data pipeline orchestration process, and encapsulates instructions for copying, reformatting, pasting, or otherwise transferring data from one or more source repositories 138 (e.g., OnPrem, GCP, Any Cloud, etc.) to one or more designated target repositories 140 (e.g., OnPrem, GCP, Any Cloud, etc.).

When the command for execution is given, the system 100 initiates an execution module responsible for carrying out the tasks defined in the DAG script. The execution module reads the instructions from the script and coordinates the data movement and transformation operations as specified, thereby assessing the necessary data from the source repositories, applies the required transformations, and transfers the data to the designated target repositories.

With continued reference to FIG. 4, in some embodiments, the user interface 112 can be used to visualize the DAG script. A DAG script represents the flow and dependencies of tasks within the data pipeline, providing a structured representation of the data movement, transformation, and validation processes. To visualize the DAG script, the user interface 112 can present a graphical representation that depicts the tasks as nodes and the relationships or dependencies between them as edges. Each task node represents a specific operation or action within the data pipeline, such as data extraction, data transformation, data loading, or data validation. The edges connecting the nodes represent the order and flow of the tasks, indicating the dependencies between them.

The visualization of the DAG script through the user interface 112 enables users to easily understand and analyze the structure and execution flow of the data pipeline. The user interface 112 can provide a visual overview of the tasks involved, their sequence, and their relationships, and can be presented in various forms, such as a flowchart, a diagram, or a graph, depending on the complexity and granularity of the data pipeline. The visual representation of the DAG script facilitates comprehension, planning, and optimization of the data pipeline, enabling users to identify bottlenecks, potential issues, or areas for improvement by visually inspecting the script. They can also trace the data flow, understand the dependencies between tasks, and assess the impact of changes or modifications to the script. Further, in some examples, the user interface 112 provides interactive features, such as the ability to zoom in or out, collapse or expand sections of the DAG script, and highlight specific nodes or edges for detailed examination, which enhances the user experience and allows for better navigation and exploration of the DAG script.

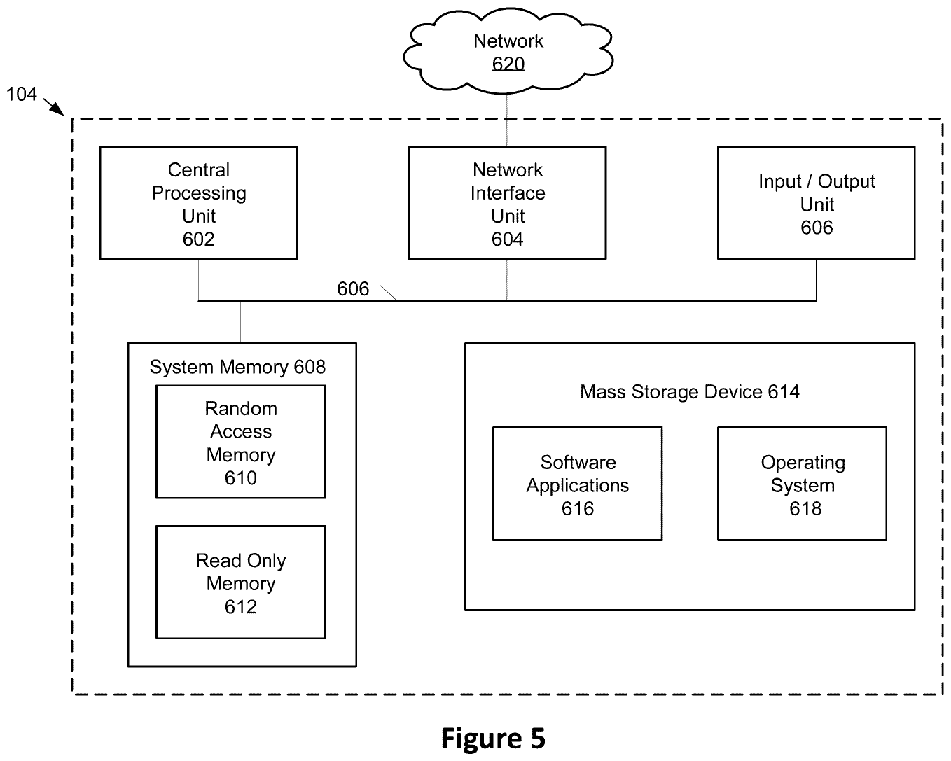

As illustrated in the embodiment of FIG. 5, the example data pipeline device 104, which provides the functionality described herein, can include at least one central processing unit (“CPU”) 602, a system memory 608, and a system bus 606 that couples the system memory 608 to the CPU 602. The system memory 608 includes a random access memory (“RAM”) 610 and a read-only memory (“ROM”) 612. A basic input/output system containing the basic routines that help transfer information between elements within the data pipeline device 104, such as during startup, is stored in the ROM 612. The data pipeline device 104 further includes a mass storage device 614. The mass storage device 614 can store software instructions and data. A central processing unit, system memory, and mass storage device similar to that shown can also be included in the other computing devices disclosed herein.

The mass storage device 614 is connected to the CPU 602 through a mass storage controller (not shown) connected to the system bus 606. The mass storage device 614 and its associated computer-readable data storage media provide non-volatile, non-transitory storage for the data pipeline device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the data pipeline device 104.

According to various embodiments of the invention, the data pipeline device 104 may operate in a networked environment using logical connections to remote network devices through network 620, such as a wireless network, the Internet, or another type of network. The network 620 provides a wired and/or wireless connection. In some examples, the network 620 can be a local area network, a wide area network, the Internet, or a mixture thereof. Many different communication protocols can be used.

The data pipeline device 104 may connect to network 620 through a network interface unit 604 connected to the system bus 606. It should be appreciated that the network interface unit 604 may also be utilized to connect to other types of networks and remote computing systems. The data pipeline device 104 also includes an input/output controller 606 for receiving and processing input from a number of other devices, including a touch user interface display screen or another type of input device. Similarly, the input/output controller 606 may provide output to a touch user interface display screen or other output devices.

As mentioned briefly above, the mass storage device 614 and the RAM 610 of the data pipeline device 104 can store software instructions and data. The software instructions include an operating system 618 suitable for controlling the operation of the data pipeline device 104. The mass storage device 614 and/or the RAM 610 also store software instructions and applications 616, that when executed by the CPU 602, cause the data pipeline device 104 to provide the functionality of the data pipeline device 104 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for data pipeline orchestration, comprising:
one or more processors; and
non-transitory computer readable storage media encoding instructions which, when executed by the one or more processors, causes the computer system to create;
a user interface configured to receive metadata configuration requirements;
a parsing module programmed to parse the metadata configuration requirements into one or more constituent components; and
a template selection module programmed to identify and select appropriate templates from a template repository used to fulfill the one or more constituent components.

2. The computer system of claim 1, wherein the metadata configuration requirements include at least one of a source data repository, a target data repository, or a transformation to be applied to data during a migration process.

3. The computer system of claim 1, wherein the metadata configuration requirements are in at least one of a JavaScript Object Notation (JSON), extensible Markup Language (XML) or Yet Another Markup Language (YAML) format.

4. The computer system of claim 1, further comprising an enterprise consideration module program to incorporate data governance requirements.

5. The computer system of claim 1, wherein the template selection module leverages artificial intelligence to identify and select the appropriate templates from the template repository.

6. The computer system of claim 1, wherein the appropriate templates encapsulate at least one of predefined logic, rules or configurations that address pipeline direct tasks or operations.

7. The computer system of claim 1, further comprising a directed acyclic graph generator script creation module configured to stitch the appropriate templates together along with data governance requirements to create a directed acyclic graph script.

8. The computer system of claim 7, wherein the user interface enables visualization of the directed acyclic graph script.

9. The computer system of claim 7, wherein the directed acyclic graph script enables parallel processing capabilities with portions of the directed acyclic graph script executed concurrently.

10. A computer program product residing on a computer readable medium having a plurality of instructions stored thereon, which when executed by a processor, cause the processor to perform operations for data pipeline orchestration comprising:
receiving metadata configuration requirements;
parsing the metadata configuration requirements into one or more constituent components; and
identifying and selecting appropriate templates from a template repository used to fulfill the one or more constituent components.

11. The computer program product of claim 10, wherein the metadata configuration requirements include at least one of a source data repository, a target data repository, or a transformation to be applied to data during a migration process.

12. The computer program product of claim 10, wherein the metadata configuration requirements are in at least one of a JavaScript Object Notation (JSON), extensible Markup Language (XML) or Yet Another Markup Language (YAML) format.

13. The computer program product of claim 10, further comprising applying one or more data governance requirements.

14. The computer program product of claim 10, further comprising leveraging an artificial intelligence model to identify and select the appropriate templates from the template repository.

15. The computer program product of claim 14, further comprising training the artificial intelligence model to identify and select the appropriate templates from the template repository using a dataset that includes various metadata configuration requirements and their corresponding successful template selections.

16. The computer program product of claim 10, wherein the appropriate templates encapsulate at least one of predefined logic, rules or configurations that address pipeline direct tasks or operations.

17. The computer program product of claim 10, further comprising stitching the appropriate templates together to create a directed acyclic graph script.

18. The computer program product of claim 17, further comprising visualizing the directed acyclic graph script.

19. The computer program product of claim 17, wherein the directed acyclic graph script enables parallel processing capabilities with portions of the directed acyclic graph script executed concurrently.

20. A computer implemented method for data pipeline orchestration, executed on a computing device, comprising:
receiving metadata configuration requirements;
parsing the metadata configuration requirements into one or more constituent components; and
identifying and selecting appropriate templates from a template repository used to fulfill the one or more constituent components.
